(19) United States
(12) Patent Application Publication
(10) Pub. No.: US 2005/0040109 A1
(43) Pub. Date: Feb. 24, 2005

(54) Method of separation of small molecules from aqueous solutions

(76) Inventors: Barbara F. Smith, Los Alamos, NM (US); Thomas W. Robison, Los Alamos, NM (US)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/646,393

(22) Filed: Aug. 22, 2003

(51) Int. Cl. B01D 61/00

(52) U.S. Cl. 210/638; 210/650; 210/651

(57) ABSTRACT

A method separating for small molecules from an aqueous solution is presented. The method can be used selectively separate small molecules from a solution while leaving untargeted molecules dissolved in the solution. The method uses polymer filtration to selectively remove the small molecules from the aqueous solution. An aqueous solution containing the dissolved small molecule is contacted with a polymer which is capable of forming a complex with the small molecule. The aqueous solution is then subjected to ultrafiltration which creates a concentrated solution of the polymer-small molecule complex. The small molecule may be released from the polymer and the polymer recycled for another round of removal.

### 1. GOVERNMENT RIGHTS

This invention was made with Government support under Contract No. W-7405-ENG-36 awarded by the United States Department of Energy to The Regents of the University of California. The Government has certain rights in the invention.

### BACKGROUND OF THE INVENTION

1. The Field of the Invention

The present invention relates to the separation of molecules from solutions. More specifically, the present invention relates to methods of selective separation of small molecules from aqueous solutions by soluble polymer ultrafiltration.

2. Technical Background

Aqueous streams such as rivers, lakes, and ground water are frequently contaminated with small soluble molecules. These contaminants may come from naturally occurring deposits. However, frequently the contaminants originate in process streams from industrial sites. Additionally, investigative laboratories such as governmental and university laboratories have produced such contaminants. Other man-made sources of water contamination include abandoned mining operations, energy production facilities, solid waste disposal facilities, and municipal waste disposal facilities. Some facilities have water systems that require in-house removal or recovery of organic and/or inorganic small molecules.

In order to reduce the amount of these small molecule contaminants in the environment, it is necessary to remove the sources of the contamination. Where a point source of contamination is readily identifiable, the contaminant may be removed from the aqueous source stream before the stream is discharged into the environment. Some of the small organic molecules that contaminate aqueous streams have been traditionally removed by oxidative destruction. However, certain contaminants are frequently found at their highest stable oxidation state. Thus, arsenic acid, silicic acid, boric acid, and phosphoric acid are not further destroyed by oxidation and are difficult to selectively remove from aqueous streams. Other small molecules that can contaminate waste streams are acids, bases, and neutral molecules. Such acids may be organic acids including diethylenetriaminepentaacetic acid (DTPA), nitrolotriacetic acid (NTA), imidodiacetic acid (IDA), and ethylenediaminetetraacetic acid (EDTA). Inorganic acid contaminants may include phosphorus acid, phosphoric acid, boric acid, silicic acid, perchloric acid, arsenous acid, and arsenic acid. Bases may include ammonia, and amines such as methylamine and dimethylamine. Neutral contaminants may include alcohols, aldehydes, nitrites, and amides as examples.

Some methods for removing such small molecules from aqueous streams have been developed. However, these methods can use chemicals that can themselves pose disposal issues. Moreover some methods require a large amount of energy that can make a removal method economically unfeasible.

Recently, systems have been developed using bacteria or other organisms that are selected or engineered to metabolize the small molecule contaminants. Such bioreactors suffer from a number of deficiencies. First, only a limited scope of small molecules may be treated by metabolization. The organisms grown in the bioreactors require a fresh supply of nutrients to optimally metabolize the contaminant. Additionally, the waste products of the organisms must be removed for the organisms to continue to thrive. These systems also produce a biomass, which must be properly disposed of in order to avoid additional contamination problems.

Other aqueous solutions may contain dissolved small molecules that need to be recovered. Such aqueous solutions may be reaction solutions in which useful compounds are synthesized. Such small molecules may include drugs, food additives, pesticides, and the like. Frequently these chemicals are produced in low yield solutions with other reaction products. Therefore, the compound must be concentrated and purified before it can be used for its intended purpose. Such purification methods may be expensive and slow. Also, the purification method itself may create additional byproducts that must be destroyed or otherwise disposed of.

Other useful small molecules are produced in aqueous solutions such as growth media from a bioreactor or serum, blood, urine or other bodily fluids from an animal. These small molecules can include polypeptides, nucleic acids, antibodies, drugs, and the like. Like chemically synthesized small molecules, these molecules must be concentrated and purified prior to use. The currently available purification methods for these types of small molecules can be very expensive. Additionally, purification methods frequently use harsh chemicals and conditions which may result in damage to the useful small molecule or to the bioreactor components. Furthermore some methods of purification are not able to selectively distinguish between a desired product and a unwanted byproduct or other contaminant.

In light of the foregoing it would be an advancement in the art to provide a method of selective separation of small molecules from an aqueous solution. It would be a further advancement if the method did not employ harsh conditions. It would be a further advancement if the method were able to rapidly separate a small molecule from a solution. An additional advancement would be achieved if the method did not produce a large amount of by products or contaminants. It would be a further advancement if the method were able to separate and concentrate dissolved molecules present at their highest oxidation state. An additional advancement would be achieved if the method were adaptable to a wide variety of dissolved small molecules.

### BRIEF SUMMARY OF THE INVENTION

The present invention provides a method for separating small molecules from an aqueous solution. The process includes contacting the aqueous solution with a pre-sized water-soluble polymer capable of forming a water-soluble polymer/molecule complex with the small molecule. The water-soluble polymer can be mixed with the aqueous solution to maximize contact of the polymer with the target small molecules of the solution. After the polymer is added to the aqueous solution, the mixture is allowed to stand for a time allowing the small molecule to form a complex with the water-soluble polymer. The solution may then be treated by ultrafiltration with an ultrafiltration membrane. The ultrafiltration membrane can be selected to allow the water and other dissolved chemicals—i.e. any unbound dissolved salts and/or other unbound small molecules—to pass through the membrane, while retaining the water-soluble polymer and the bound small molecules. Thus, a concentrated solution containing the water-soluble polymer is created thereby separating the target small molecule from the aqueous solution. The bound target small molecule can be released from the aqueous solution containing water-soluble polymer/molecule complex, and the polymer recycled for another round of binding and filtration. The water-soluble polymer may be dissolved in a reaction solution prior to contacting the aqueous solution with the polymer. With the polymer dissolved in a reaction solution, the polymer may more readily mix with the aqueous solution thereby reducing the time needed for the separation process. When the polymer is dissolved in a reaction solution, the aqueous solution may be contacted with the polymer by mixing the reaction solution with the aqueous solution.

A number of small molecules may be separated from aqueous solutions by the process of the present invention. Such molecules include inorganic molecules such as sulfuric acid, phosphoric acid, boric acid, arsenic acid, perchloric acid, arsenous acid, silicic acid, selenic acid and the like. Other small molecules that may be removed/recovered from an aqueous solution include small organic molecules that are acids, bases, or neutrals, for example antibodies, nucleic acids, polypeptides, pharmaceutical compounds, and the like.

The water-soluble polymer used to form a complex with the small molecule may have one or more binding groups, which is selected to bind the small molecule. Such binding groups may be diol derivatives, thiol derivatives, amide derivatives, polyphosphonic acid derivatives, cavity-containing host groups, affinity groups, and the like.

The polymer may have a molecular weight selected to be retained by an ultrafiltration membrane. Polymers with a molecular weight in the range from about 5,000 to about 100,000 have been successfully used with the method of the present invention. A number of water-soluble polymers have been used with the separation method. Such water-soluble polymers include polyethylenimine (PEI), permethylated polyethylenimine (PEIM), guanidinium polyethylenimine (PEIG), carboxylated polyethylenimine (PEIC), phosphoralated polyethylenimine (PEIP) poly(ethylenimine ethylenesulfide) (PEI-thiol), glycidol polyethylenimine (PEI-Diol), tartrated polyethylenimine (PEI-Tartrate) and diphosphoralated polyethylenimine (PEIDiP).

As discussed previously, the water-soluble polymer used with the method of the present invention may have a water-soluble backbone polymer to which small-molecule binding-groups are attached. PEI is one polymer that may be used as a polymeric backbone. Binding groups can be attached to the backbone polymer in different ratios of binding group attachment sites. The binding groups are selected to bind specific target small molecules. In certain embodiments, the bindings groups may include a tartrate derivative, a diol, a triol, a tetraol, a thiol, a dithiol, a cage-shaped host, a calixarene, an antibody, a Fab fragment of an antibody, a F(ab)₂ of an antibody, a polypeptide, an antigen, and like binding groups that have an affinity for small molecules.

The water-soluble polymer may be purified prior to contacting the aqueous solution with the polymer. Such pre-purification of the polymer can ensure that the polymer and any complexed small molecules will be retained by the ultrafiltration membrane during the ultrafiltration step under the processing conditions. The pre-purification can select for polymers with a molecular size capable of being retained by a first ultrafiltration membrane having a molecular weight cutoff (MWCO) of a first preselected level. The pre-purified water-soluble polymer may also be essentially free of polymer molecular sizes capable of passing through a second ultrafiltration membrane having a MWCO of a second preselected level. The first and second preselected levels of the first and second ultrafiltration membranes may be selected from any number of MWCO. Generally, the MWCO of the membranes will be in the range from about 5,000 to about 100,000. A MWCO of about 10,000 to 30,000 has been used. Generally the first preselected MWCO level is larger than the second pre-selected MWCO level.

### BRIEF DESCRIPTION OF THE DRAWINGS

A more particular description of the invention briefly described above will be rendered by reference to specific embodiments thereof which are illustrated in the appended drawings. These drawings depict only typical embodiments of the invention and are not therefore to be considered to be limiting of its scope. The invention will be described and explained with additional specificity and detail through the use of the accompanying drawings in which:

FIGS. 1A through 1E illustrate the chemical structure of some compounds which may be used with the present invention.

FIG. 2 is a schematic representation of a system for use with the method of selective separation of small molecules from aqueous solutions.

FIG. 3 is a schematic representation of a system for use with the method of selective separation of small molecules from aqueous solutions.

FIG. 4 is a plot of percent boron removed as a function of pH for PEI-Diol and PEI-Tartrate.

FIG. 5 is a pH dependency study for the binding of 100 ppm Si(OH)₄ with 1% wt/v solutions of water-soluble metal-binding polymers.

FIG. 6 shows Percent As removed as a function of pH after 1 hour of contact. Initial concentration of As(III) and As(V) were 10 ppm and initial concentration of PEI and PEIET were 3000 ppm.

FIG. 7 shows percent As(III) removal as a function of sulfate concentration at pH 7 after 39 hours of contact. Initial concentration of As(III) was 107 ppm and initial concentration of PEI and PEI-ET were 15,000 ppm.

FIG. 8 shows the way in which a guanidinum group capable of forming a PEIG polymer may be used to bind phosphonic acid derivatives and carboxylic acid derivatives.

FIG. 9 shows a method for preparing a PEI-18-Crown-6 water-soluble polymer as well as the way in which such a crown ether may be used to bind an ammonium ion.

FIG. 10 shows a cartoon of the formation of an inclusion complex between calyx[4]arene attached to a polymer (P) and a guest (G).

FIG. 11 gives examples of molecules containing a boron atom capable of functioning as a Lewis acid center that may be attached to a water-soluble polymer.

### DETAILED DESCRIPTION OF INVENTION

The present invention relates to methods for separation of small molecules from aqueous solutions. A method of selectively separating small molecules is disclosed which involves contacting an aqueous solution containing the small molecule with a water-soluble polymer. The water-soluble polymer is selected for its ability to bind the small molecule. Together the water-soluble polymer and the small molecule form a complex or the small molecule becomes a guest of the host soluble polymer. The aqueous solution can be contacted with the water-soluble polymer by mixing the water-soluble polymer or a reaction solution containing the water-soluble polymer with the aqueous solution. The aqueous solution and the water-soluble polymer are allowed to sit for a period of time sufficient for the small molecule to form a complex with the water-soluble polymer. The time required to form a complex may depend on the polymer used, the specific small molecule, other chemicals present in the aqueous solution, pH of the solution, and the temperature of the solution. Generally a period of time between about a few seconds and 24 hours is sufficient for the complex to form.

As used herein the term small molecule refers to a soluble molecule other than simple metals or metallic ions. Small molecules can be categorized as acids, bases or neutrals. Such small molecule inorganic acids can be contaminants that are frequently present in aqueous streams such as sulfuric acid (H₂SO₄), phosphoric acid (H₃PO₄), perchloric acid (HClO₄), boric acid (B(OH)₃), arsenic acid (H₃AsO₄), silicic acid (Si(OH)₄), selenic acid (H₂SeO₄), selenous acid (H₂SeO₃), antimonous acid (HSbO₂.H₂O), and the like. Organic acids can include acrylic acid, N-methyliminodiacetic acid, DTPA, nitrilotriacetic acid (NTA), imidodiacetic acid (IDA), and ethylenediaminetetraacetic acid (EDTA), and the like. Bases may include ammonia, and amines such as methylamine, and dimethylamine and the like. Neutral contaminants include alcohols, aldehydes, nitrites, and amides as examples. Neutral small molecules can include maleimide, maleonitrile, fumaronitrile, and acrylamide, as other examples of small organic molecules. These small molecules are frequently found in waste streams from industrial sites, governmental laboratories, and mines. Additionally, certain contaminants can be found in municipal waste streams, coal power and nuclear power plant wastes as well as be naturally occurring contaminants in streams, rivers, lakes, and ground water.

The term small molecules also includes chemicals which are produced in reaction mixtures. Chemicals such as organic compounds are produced for example to be food additives, drugs, pesticides and the like. These small molecules must generally be removed from the reaction mixture and purified prior to use. Other small molecules may be produced in bio-reactors. The bioreactors may have organisms such as viruses and bacteria and other cells which were selected for their ability to produce a desired small molecule. Alternatively, the bioreactors may contains organisms or cells, which were engineered to produce a desired small molecule. Such molecules include polypeptides, antibodies, pharmaceutical compounds, antibiotics, coenzymes, drugs, and the like. These small molecules are produced in a broth or other growth media, which contains nutrients for the cell or organism as well as the waste products of the cell or organism and the cell or organism itself. For these small molecules to be used for their intended purposes they must be separated from the aqueous growth media and purified.

Other useful small molecules such as antibodies, polypeptides, nucleic acids, and the like, may also be produced by animal. These molecules can be found in fluids such as blood, urine, milk, and the like and require separation and purification.

The water-soluble polymer can be selected from a number of water-soluble polymers. Generally, the water-soluble polymer has a molecular weight selected for use in ultrafiltration. Ultrafiltration uses a filtration membrane which has pores of a small size. The pore size is also referred to as the molecular weight cut-off (MWCO). The molecular weight of the polymer is selected to be larger than the MWCO of the membrane. Thus, when a solution containing the soluble polymer is filtered through the ultrafiltration membrane, the polymer is retained while the water and dissolved unbound molecules pass through the filter. Generally, the soluble polymer may have a molecular weight in the range from about 1,000 to about 1,000,000. More specifically, the soluble polymer may have a molecular weigh in the range from about 5,000 to about 100,000. The MWCO of the ultrafiltration membrane may be in the range from about 1,000 to about 1,000,000 provided that the MWCO is smaller than the molecular weight of the polymer. In one embodiment, a solution of polymers having an average molecular weight of about 10,000 is used. In another embodiment, a solution of polymers having an average molecular weight of about 30,000 or 100,000 is used.

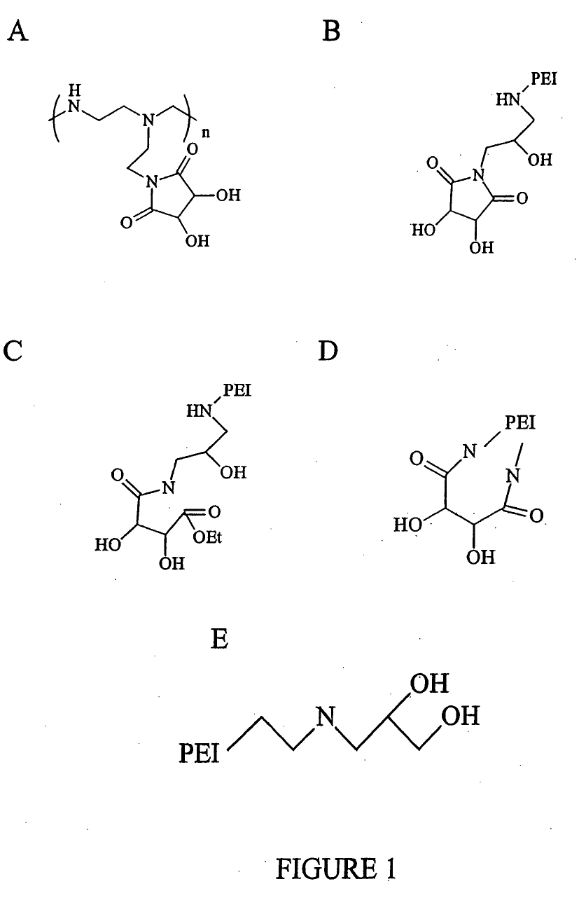

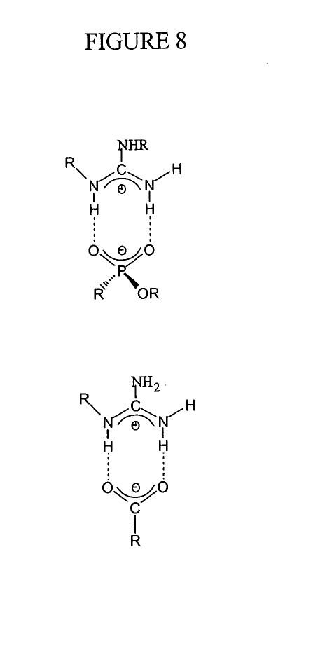

Polymers that can be used with the present invention include polyethylenimine (PEI), and modified PEI polymers such as PEIM, PEIC, PEIP, PEI-Diol, PEI-triol, PEI-tetraol, PEI-Thiol, PEI-Dithiol, PEI-Tartrate, PEI-DiP, PEI-Tris. An additional modified PEI polymer is PEIG, which may be used to bind phosphonic acid derivatives and carboxylic acid derivatives as shown in FIG. 8. PEI-Thiol comprises a PEI-backbone with ethylenethiol attached. PEI-Dithiol comprises a PEI-backbone with lipoic acid attached and reduced to give the dithiol groups. PEI-Diol comprises a PEI-backbone with a glycidol group attached to give a diol. PEIDiP comprises a PEI-backbone attached to a beta-diphosphoric acid group. PEI-Tartrate comprises a PEI-backbone with one or more tartrate groups or tartrate derivatives covalently linked to an amine group of the PEI-backbone. Such tartrate derivatives may be the open monoester (C), the diamide-linked tartrate (D), or the cyclic tartrate (A or B) shown in FIG. 1. Since direct addition of the diethyl-L-tartrate to PEI can give rise to several different structures of the diol-containing tartrate, another approach to obtain the cyclic imidetartrate is to directly attach the imidetartrate to the PEI either through an epichlorhydrin linker group or a chloroacetylchloride linker group. Another way to link the imidetartrate is to from the imide with some group such as reacting ethanolamine with diethyltartrate to form the imide with a hydroxy functionality that can be activated and attached to a polymeric backbone. Further reduction of the carbonyls to alcohols would give a tetraol binding agent. PEI-Tris comprises a PEI-backbone with a tris triol group attached. Other triol-containing functional groups can be obtained by reaction of a protected and activated 1,2,3,4-butanetetrol to PEI or reaction of 1-epoxy-3,4-butane with PEI or a similarly soluble polymer that has an oxygen or nitrogen group. All these binding groups can be attached to the backbone polymer in different proportions from every possible site functionalized to only some sites functionalized. Polymers PEI, PEIM, PEIC, PEIP, PEI-Thiol, PEIG can be prepared in accordance with the methods and teachings of U.S. Pat. No. 5,928,517, which description and disclosure is herein incorporated by reference.

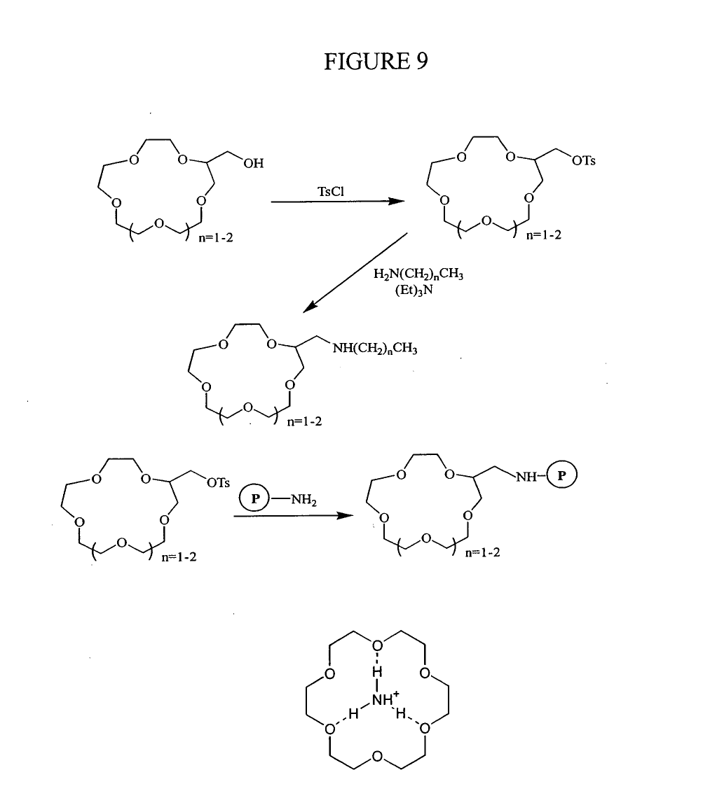

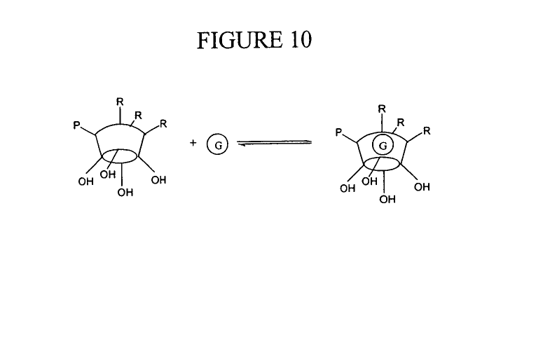

PEI-CDα, PEI-CDβ, and PEI-CDδ can comprise a PEI-backbone attached to a 5-, 6- or 7-ring cyclodextran group respectively, which can host a variety of small molecules based on hydrophobicity, fit within the cyclodextran cavity, and/or reactivity with the polyol groups. PEI-18-Crown-6 can comprise a PEI-backbone attached to an 18-crown-6 group where the crown moiety can readily bind ammonia. The methods of preparing such PEI-18-Crown-6 is described in U.S. Pat. No. 5,928,517 which, as noted above, is herein incorporated by reference as well as in FIG. 9. FIG. 9 also shows the way in which crown ethers may be used to bind small molecules such as ammonia. PEI-Calix[N]arene can comprise a PEI-backbone attached to calixarenes groups with various N-sized rings and various groups attached to the aromatic rings. FIG. 10 gives an example of how PEI-Calix[N]arene may form an inclusion complex with a small molecule such as iodine or ammonia.

In certain embodiments, the water-soluble polymer has the chemical formula of FIG. 1A where n is an integer between about 12 and about 12,000. The polymer may also have a polymeric backbone such as PEI with one or more binding groups bound to the backbone. Such polymers may have the chemical formulas shown in FIGS. 1B, 1C, 1D, 1E, and 1F. The backbone polymer can have a molecular weight in the range from about 1,000 to about 1,000,000. A polymer with a molecular weight in the range from about 5,000 to about 100,000 has been successfully used.

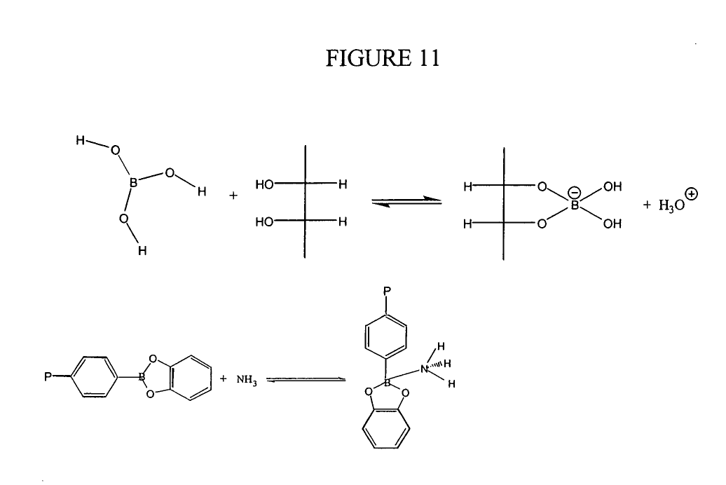

The water-soluble polymer used in the present invention can be a grafted polymer. A grafted polymer has a polymeric backbone to which one or more molecule-binding groups are covalently linked. Such polymeric backbone polymers may be, for example, PEI (polyethylenimine), polyvinylamine (PVA), polyallylamine (PAA), polyacrylic acid, polymethacrylic acid, polyvinylalcohol, polyvinylacetate, polypyrrol, or other synthetic soluble polymers. Though most any synthetic soluble plymer can be used, hyperbranched polymers work particularly well. The molecule binding groups may be a diol, a triol, a tetrol, a thiol, a polythiol, an antibody, a Fab fragment of an antibody, a F(ab)₂ of an antibody, a protein, an antigen, or the like. Another small molecule binding group can include cage or large hosts that can encapsulate the guest or target molecule. These can include crown ethers, calixarenes, cryptands, cyclophanes, cyclodextrans, and the like. Additionally, molecules containing an atom capable of functioning as a Lewis acid center, such as the molecules shown in FIG. 11, may also be used as a binding group attached to the water-soluble polymer. The molecule binding groups allow the water-soluble polymer to selectively bind a molecule for removal from a solution.

The method of removing small molecules can be used with a variety of aqueous streams. For example, the small molecule can be a contaminant found in naturally occurring aqueous streams. For example, tap water may contain contaminants such as silicic acid, arsenic acid, or boric acid. A polymer can be designed to selectively bind such molecules allowing for the molecules to be removed from the aqueous stream by ultrafiltration. Inorganic and organic small molecules may both be removed from aqueous solutions by the present method. Such molecules may include acids, bases, and neutral molecules. Organic acids that may be of interest include DTPA, NTA, IDA, and EDTA. Other small molecules may include inorganic acids such as phosphorous acid, phosphoric acid, arsenic acid, arsenous acid, selenic acid, antimonous acid, and the like. Basic molecules can include ammonia, and various amines such as methylamine and alkylamines in general or aromatic amines or polyamines.

Many organic compounds that are prepared for use as herbicides, drugs, food additives, and the like are prepared in aqueous solutions. To use these molecules for their intended purposes they must be removed from the solution and purified. The method of the present invention can be used to collect and concentrate such small molecules. For example a binding group may be a antibody, a Fab fraction of an antibody, a F(ab)₂ portion of an antibody, a polypeptide, or other binding group specifically designed to bind the small organic compound.

Additionally, therapeutic proteins such as insulin, monoclonal antibodies, and the like as well as drugs such as antibiotics are frequently produced in cell cultures. The cell cultures are generally grown in broths in bioreactors. The broths may contain nutrients, vitamins, hormones, and other chemicals necessary for the growth of the cell and the production of the desired therapeutic molecule. The therapeutic molecules are therefore produced by the cells and released into the broth. Thus, the therapeutic molecules are contained in a solution that contains many contaminants. For these therapeutic molecules to be used for their intended therapeutic purpose, the molecules must be separated from the broth and purified. Thus, the method of the present invention can be used to selectively bind, remove, and purify such therapeutic molecules. For example, a solution containing a human monoclonal antibody can be mixed with a solution containing a soluble polymer with a binding group selected to bind the monoclonal antibody. Such binding group can be, for example, an anti-human antibody, or a Fab or a F(ab)₂. Additionally, the binding group can be an antigen or other group that will bind to the monoclonal antibody.

After the aqueous solution is contacted by the water-soluble polymer for a sufficient period of time to form water-soluble polymer-small molecule complex, the polymer-molecule complex can be separated from the aqueous solution. Such separation of the polymer-molecule complex can be accomplished by ultrafiltration. Ultrafiltration is a pressure driven separation process occurring on a molecular scale. As a pressure gradient is applied to a process stream contacting the ultrafiltration membrane, liquid including small dissolved materials is forced through pores in the membrane while larger dissolved materials and the like are retained in the process stream.

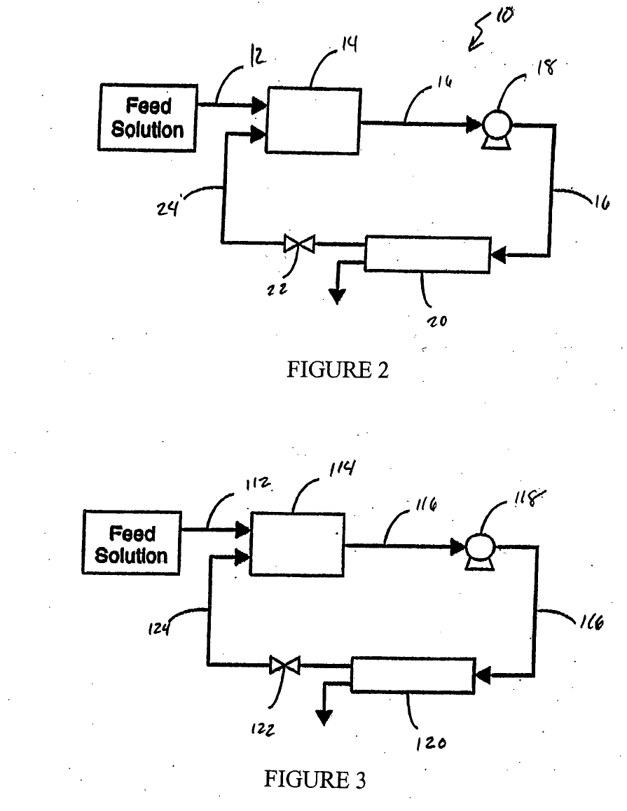

Referring to FIG. 2, a schematic diagram of a separation system 10 that can be used to separate a small molecule from an aqueous solution is illustrated. A feed solution of the aqueous solution containing the dissolved small molecule can be supplied to the system through a supply line 12. The feed solution can be contacted with a water-soluble polymer in a reaction tank 14. The water-soluble polymer can be contained in a reaction solution. After a period of time the water-soluble polymer forms a complex with the dissolved small molecule. The solution containing the polymer-small molecule complex can be transmitted through a second line 16 and a pump 18 to a separation chamber 20. The separation chamber contains an ultrafiltration membrane. The ultrafiltration membrane has a MWCO that is less than the molecular weight of the water-soluble polymer. As the aqueous solution is forced through the ultrafiltration membrane, the polymer-small molecule complex is retained.

Both the water-soluble polymer-small-molecule-complex and any uncomplexed water-soluble polymer are retained by the membrane of the ultrafiltration unit. Water and other dissolved chemicals can pass through the membrane. The retention of solutes during ultrafiltration depends on the membrane pore size. The molecular weight cut-off (MWCO) is generally defined as the molecular weight of spherical, uncharged solute that is 90 percent retained by the membrane. Thus, both size and shape can influence the MWCO. But for these applications, the pre-purification of the polymer, for example, through a larger MWCO ultrafiltration membrane and the use of a smaller MWCO ultrafiltration membrane in the process, assures that essentially none of the soluble polymer and soluble-polymer complexes pass through the membrane, and is critical to the functioning of the process. By use of ultrafiltration, the water-soluble polymer-small molecule complex can be separated from the solution. After the separation, the small molecule can be separated from the water-soluble polymer-small molecule complex concentrate for recovery, recycling, or disposal as desired.

Generally, there are two modes of operation in ultrafiltration. The first is a batch or concentration mode, shown in FIG. 2, where the volume in the retentate is reduced by simple filtration. The second mode is diafiltration with the ultrafiltration unit as shown in FIG. 3. Referring to FIG. 3, a process for recovering small molecules from the concentrated water-soluble polymer-small molecule complex can include adding a stripping solution to a concentrated solution of water-soluble polymer-small molecule complex. The stripping solution is added to a tank 114 of the complex via a line 112. The stripping solution adjusts the chemistry of the solution such that the small molecule is released from the water-soluble polymer. This solution of dissociated polymer and small molecules is conveyed through a second line 116 by a pump 118 to a separation chamber 120. Generally, the separations chamber 120 contains an ultrafiltration membrane, having a MWCO less than the molecular weight of the water-soluble polymer. The ultrafiltration membrane retains the water-soluble polymer and allows water and the dissolved small molecule to pass through.

During diafiltration, as permeate is generated, solute-free liquid, e.g., dilute mineral acid, is added to the retentate at the same rate as permeate is separated thereby maintaining constant volume within the ultrafiltration unit. In diafiltration, the lower molecular weight species or small molecules in solution are removed at a maximum rate when the rejection coefficient for the membrane equals zero. Other possible stripping solutions can include one or more of the following: deionized water, basic solution, acidic solution, organic solvents, hot water, cold water, competing ligands, and the like that will reverse the polymer-binding process. Another mode of recovery of the small molecules after they have been concentrated through ultrafiltration is to apply a potential to the solution and separate the molecules from the polymer in an elctrodialysis membrane system.

In the present process, an ultrafiltration unit can generally consist of hollow-fiber cartridges of membrane material having a MWCO from about 1000 to 1,000,000, preferably from 10,000 to 100,000. Other membrane configurations such as spiral-wound modules, stirred cells (separated by a membrane), thin-channel devices, centrifugal devices, and the like may also be used although hollow-fiber cartridges are generally preferred for the ultrafiltration unit. Among the useful ultrafiltration membranes are included cellulose acetate, polysulfone, polyethers, and polyamide membranes such as polybenzamide, polybenzamidazole, and polyurethane or combinations of material types. Other membrane materials that are inorganic can be used including stainless steel and ceramic materials and other inorganic composites.

### EXAMPLES

The following examples are given to illustrate various embodiments which have been made within the scope of the present invention. The following examples are neither comprehensive nor exhaustive of the many types of embodiments which can be prepared in accordance with the present invention.

### Example 1

### Polymer Binding of Cobalt in the Presence of Boron

A standard solution of 10,000 ppm boron was made from boric acid. The solution was heated in order to dissolve all the boric acid. A portion of the standard solution was added to a solution containing 1% polymer and 20 ppm cobalt. The final concentration of the boron in the solution was approximately 3000 ppm. The pH of the solution was adjusted to neutral pH by the drop wise addition of HNO₃ or NaOH. The following polymers were tested for their ability to bind cobalt in the presence of boric acid: PEIC, PEIM, PEIP, and PEI-DIP. Two solutions were prepared for each polymer. The solutions were allowed to sit for a period of time ranging from about 80 minutes to about 130 minutes. After which the solutions were subjected to ultrafiltration. Permeate was collected and diluted with nitric acid and de-ionized water (1:1 dilution). The cobalt and boron concentration in permeate was analyzed. The results of which are shown in Table 1. None of these polymers bound boric acid to any significant extent, but three of the polymers were good binders for cobalt in the presence of high concentrations of boric acid showing selectivity for cobalt and against boric acid. This data indicates that neither the PEI backbone nor these functional groups attached to the soluble polymer, such as carboxylates, phosphonic acids and quaternary amines, were significant binders of boric acid. Time also did not appear to be a significant factor to boric acid or cobalt binding with these polymers. Other functional groups or guest molecules would need to be prepared to selectively bind boric acid (see following examples).

TABLE 1
Cobalt binding studies in the presence of excess boron.

| | | Contact Time | B in | Co in |
|---|---|---|---|---|
| Polymer | pH | (min.) | Permeate | Permeate |
| PEIM | 6.96 | 80 | 3700 ppm | 6.96 ppm |
| PEIM | 7.10 | 105 | 3700 ppm | 7.10 ppm |
| PEIC | 7.06 | 85 | 3600 ppm | 0.0 ppm |
| PEIC | 7.05 | 120 | 3400 ppm | 0.0 ppm |
| PEIP | 6.97 | 130 | 3700 ppm | 0.0 ppm |
| PEIP | 6.94 | 130 | 3600 ppm | 0.2 ppm |
| PEIDiP | 7.08 | 105 | 3700 ppm | 1.0 ppm |
| PEIDiP | 6.97 | 110 | 3600 ppm | 1.0 ppm |

### Example 2

### Preparation of Diol Polymer (PEI-Diol)

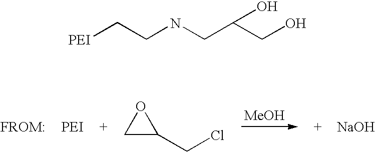

For the preparation of the above in a 1:1 PEI/reactant ratio, 2.0 g (0.042 mol) of a 90:10 PEI:H₂O solution and 3.93 g (0.042 mol) of epichlorohydrin from Aldrich were each dissolved in 50 mL of anhydrous methanol and placed in separate syringes fitted with 8 in. needles. The two syringes were mounted onto a SAGE Syringe Pump Model 351 that allowed the simultaneous addition of the PEI and epichlorohydrin in equal concentrations to the reaction flask. The reagents were added dropwise at a rate of 1 mL/min into 20 mL of anhydrous MeOH under Argon with rapid stirring. After the addition was complete, the clear, colorless solution was allowed to stir for 24 hours at ambient temperature under Argon. Then, 42 mL (0.042 moles) of a 1.0 M standardized KOH/MeOH solution was added dropwise and the reaction brought up to reflux. After refluxing for several hours, the KCl was filtered and the MeOH removed under vacuum leaving a thick, translucent residue. The residue was dissolved in 100 mL of H₂O and then purified by ultrafiltration through a 30,000 MWCO membrane from A/G Technology. Once six volume equivalents (600 ml) of permeate were collected, the aqueous concentrate solution was collected and then frozen in liquid N₂. Drying under vacuum to a constant weight gives 2.43 g of a white powder in 50% yield. Elemental Analyses: (C) 54.49%, (H) 9.79%, (N) 13.31%, (Cl)<2%. Percent fictionalization based on the C/N ratio with respect to one functional unit for every monomer unit: 50%.

### Example 3

### Preparation of Tartrate-Containing Polymer (PEI-Tartrate)

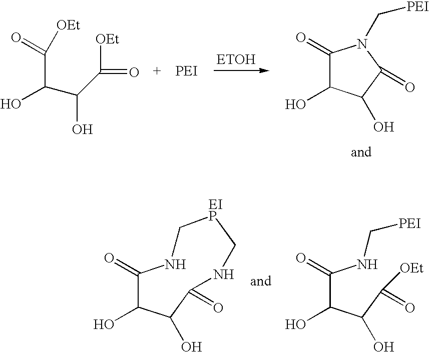

Diethyl-L-tartrate (2 g) was reacted with PEI (1.25 g, 30K MWCO) in ethanol (33 mL) while stirring under reflux for 15 hours. The solvent was removed under vacuum and the residue dissolved in 55 mL of water and the solution diafiltered (30K MWCO) with 5 volume equivalents of water to purify the polymer. After freeze drying the purified polymer solution 1.63 grams of product was obtained. An IR of the product gave a carbonyl stretch at 1654 cm⁻¹, and very little at 1735 cm⁻¹ for the starting ester, indicating that most of the addition went to forming the imide polymer.

### Example 4

### Preparation of Tris-Triol Polymer

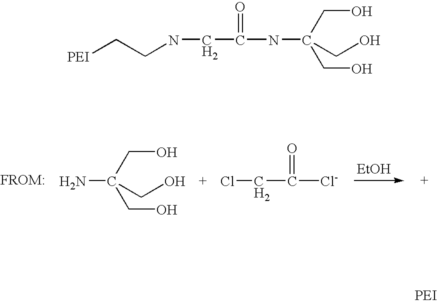

5 grams (0.04 mol) of TRIS [Tris(hydroxymethyl)aminomethane] from Aldrich was dissolved in 200 mL warm ethanol and then 1 equivalent (4.04 g) of triethylamine was added. After the ethanolic solution had cooled slightly (the TRIS fell out of solution at room temperature) 1.2 equivalents (5.42 g) of chloroacetyl chloride was added dropwise. The cloudy mixture was refluxed for 45 minutes and the ethanol removed by roto-evaporation. The resulting white semi-solid was dried in a vacuum oven at 60° C. overnight to give the compound below.

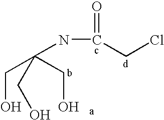

H NMR: a 4.8 ppm, b 3.75 ppm, d 3.82 ppm. FTIR: c 1631 cm−1.

The above product was brought up in water and then added to a 1% aqueous solution of 3.63 grams (2 equivalents) of 30K MWCO PEI assuming a 5% water content. The mixture was brought to reflux and then 1 equivalent (1.6 g) of NaOH was added dropwise as a 10 M solution. After refluxing for two hours, the mixture was cooled to room temperature and then ultrafiltered through a 30K MWCO membrane through six volume equivalents. The product was left in solution as it becomes insoluble in water once it was dried under vacuum. Yield (based on dry weight): 85%. Elemental Analysis: (C) 40.73%, (H) 10.07%, (N) 19.75%. Percent functionalization based on C/N ratio with respect to one functional unit for every monomer unit: 36%.

### Example 5

### Preparation of Dithiol Polymer

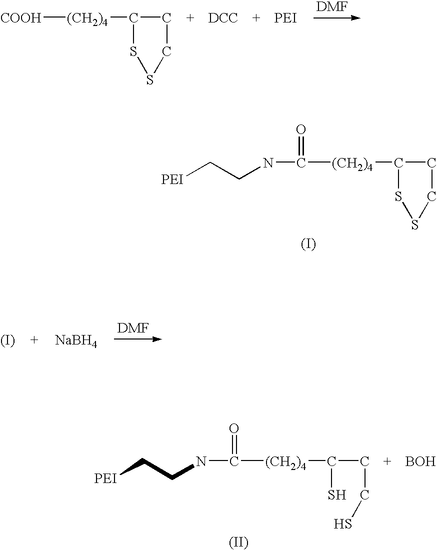

To 10.66 g (0.24 mol, 10 equiv, MWCO 30K) of PEI in DMF at 25° C. was added a solution of 5.0 g (0.024 mol, 1 equiv) dl-thiotic acid from Acros and 5.36 g (0.026 mol, 1.1 equiv) DCC from Kodak in 25 mL DMF. This was heated to 60° C., with stirring under inert atmosphere, for 24 hours. After filtering the DCU, 1.10 g (0.029 mol, 1.2 equiv) of NaBH₄ was added. After stirring for three hours the DMF was removed under high vacuum and the residue was suspended in 400 mL of water. The white, translucent B(OH)₃ was removed by filtration through a 0.45 micron syringe filter. The clear, semi-translucent liquid was then ultrafiltered through a 30K MWCO UF membrane, collecting 7.5 volume equivalents of permeate. The polymer was left in solution as it becomes insoluble when dried under vacuum. Approximately 7 grams of polymer was produced by this reaction for a 20% yield.

### Example 6

### Polymer Binding of Boron at Varying pH

The ability of different polymers to bind boron at various pH levels was investigated. A set of solutions containing 100 ppm boron as boric acid were created. Each solution also contained PEI, PEI-Diol, or PEI-Tartrate at a concentration of 1%. The pH of each solution was adjusted using NaOH or HCl to pH 3, 7 or 11. The solutions were allowed to sit for a period of time to allow the polymer to bind to the boric acid. After sufficient time, the solutions were subjected to ultrafiltration, and permeate was analyzed for boron concentration. It was found that PEI was unable to bind boric acid at any of the pH values. PEI-Diol binding was maximal at pH 11 with about 50% of the boron bound. PEI-Tartrate was the most efficient binder of boric acid studied with a binding of 80% of the boric acid at pH 7.

### Example 7

### PEI-Tartrate Binding of Boron at Varying pH

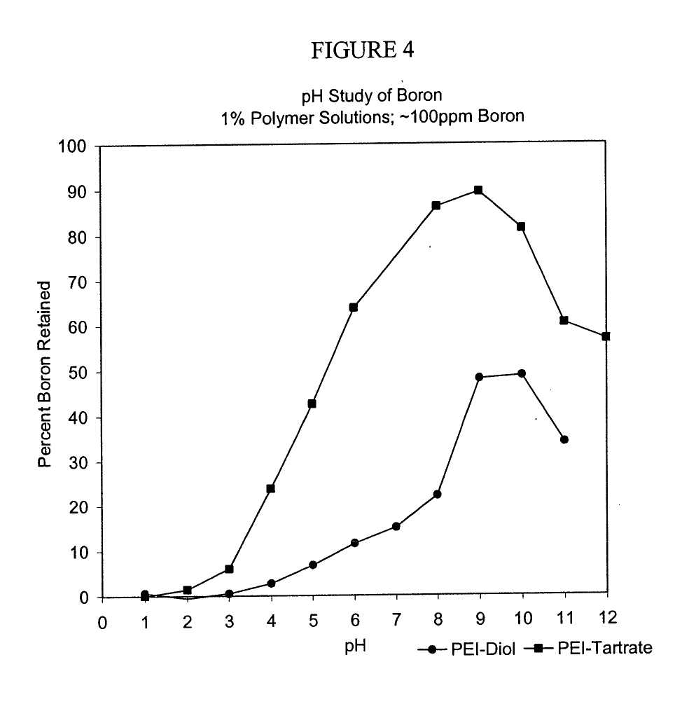

In the previous example PEI-Tartrate was found to be the most efficient binder of boron. An experiment was designed to further explore the boric acid binding capabilities of PEI-Tartrate. Twelve samples were prepared each containing 1% polymer and 100 ppm boron. Each sample had a pH between 1 and 12. The pH was adjusted for each sample by the addition of HCl or NaOH. Each sample was stirred and then allowed to sit for the binding of the polymer to the boron. The samples were then subjected to ultrafiltration and permeate analyzed for boron concentration. The results of the binding study are shown in Table 2 and plotted in FIG. 4. The ability of PEI-Tartrate appears to be maximal at a pH range of about 8.0 to about 10.0. At higher pH levels the polymer is competing with hydroxide formation, which limits the percent of boric acid retained. This creates a maximal binding, which begins to drop off at a pH of about 11.0.

TABLE 2
Binding of Boron as a Function of pH.

| | | Boron in Permeate | % Boron Retained |
|---|---|---|---|
| Polymer | pH | (ppm) | by the Polymer |
| Blank | | 111.4 | — |
| PEI-Tartrate | 1 | 112.9 | 0% |
| PEI-Tartrate | 2 | 109.8 | 1.436% |
| PEI-Tartrate | 3 | 104.7 | 0.014% |
| PEI-Tartrate | 4 | 94.98 | 23.75% |
| PEI-Tartrate | 5 | 63.93 | 42.61% |
| PEI-Tartrate | 6 | 40.30 | 63.82% |
| PEI-Tartrate | 7 | — | — |
| PEI-Tartrate | 8 | 15.36 | 86.21% |
| PEI-Tartrate | 9 | 11.73 | 89.47% |
| PEI-Tartrate | 10 | 20.77 | 81.36% |
| PEI-Tartrate | 11 | 44.12 | 60.39% |
| PEI-Tartrate | 12 | 48.17 | 56.76% |

### Example 8

### PEI-Diol binding of Boron at Varying pH

The ability of PEI-Diol to bind boron at varying pH values was investigated. Eleven samples were prepared between pH of 1 to 11, each containing 1% polymer and 100 ppm boron as boric acid. The pH was adjusted for each sample by the addition of HCl or NaOH. Each sample was stirred and then allowed to sit for the binding of the polymer to the boron. The samples were then subjected to ultrafiltration and permeate analyzed for boron concentration. The results of the binding study are shown in Table 3 and in FIG. 4. The ability of PEI-diol appears to be maximal at a pH of about 9.0 to about 10.0. At higher pH values the polymer is competing with hydroxide formation, which limits the percent of boron retained. This creates a maximal binding, which begins to drop off at a pH of about 11.0.

TABLE 3
Binding of Boron by PEI-Diol as a Function of pH.

| | | Boron in Permeate | % Boron Retained |
|---|---|---|---|
| Polymer | pH | (ppb) | by the Polymer |
| Blank | | — | — |
| PEI-Diol | 1 | 99.33 | 0.67% |
| PEI-Diol | 2 | 100.5 | −0.50% |
| PEI-Diol | 3 | 99.45 | 0.55% |
| PEI-Diol | 4 | 97.25 | 2.75% |
| PEI-Diol | 5 | 93.23 | 6.77% |
| PEI-Diol | 6 | 88.50 | 11.50% |
| PEI-Diol | 7 | 84.98 | 15.02% |
| PEI-Diol | 8 | 77.90 | 22.10% |
| PEI-Diol | 9 | 51.91 | 48.09% |
| PEI-Diol | 10 | 51.21 | 48.79% |
| PEI-Diol | 11 | 65.99 | 34.01% |

### Example 9

### Boric acid Binding Over Time

It was previously determined that the ability of the PEI-Tartrate and PEI-Diol to bind boron was affected by pH. An experiment was designed to determine if the effect of time of contact with the polymers before ultrafiltration had an effect on the amount of boric bound by the polymer. Three sets of four solutions were created. Each solution contained 1% polymer and had a boron concentration of 100 ppm. The first two solutions contained PEI-Tartrate, and the second two solutions contained PEI-Diol. The solutions had either a pH of 6.0 or 9.0. The solutions were stirred on a shaker. A first set of solutions was subjected to ultrafiltration immediately upon preparation of the solution. A second set of solutions was subjected to ultrafiltration after 30 minutes of shaking. A third set of solutions was subjected to ultrafiltration after being shaken overnight. Permeate from each solution was analyzed for boron concentration. As seen in Table 4, the PEI-Tartrate was a better binder of boron. A slight improvement in boron binding was seen after being mixed overnight but the increase was not significant, indicating that the binding reaction was fast relative to the sampling time.

TABLE 4
The effect of time and mixing on boron binding.

| | | % Boron Retained | | |
|---|---|---|---|---|
| Polymer | pH | No time | 30 minutes | Overnight |
| PEI-Diol | 6.0 | 1.84 | 1.49 | 1.57 |
| PEI-Diol | 9.0 | 38.75 | 39.21 | 40.32 |
| PEI-Tartrate | 6.0 | 55.09 | 55.08 | 58.04 |
| PEI-Tartrate | 9.0 | 70.6 | 86.5 | 89.24 |

### Example 10

### Binding of Silicic Acid as a Function of pH with Three Polymers

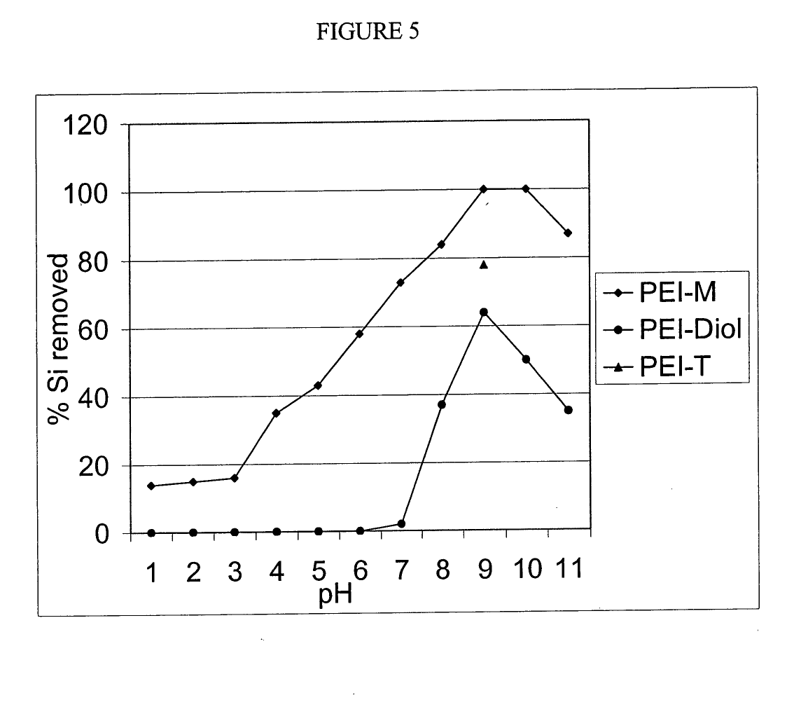

Experiments have been performed to test the removal of silicic acid (Si(OH)₄) from aqueous systems. These studies were performed as a function of pH between 1 and 12 at a starting Si(OH)₄ concentration of 100 ppm using several different polymers. No ionic strength adjusters were added. The experiments were performed by preparing Si(OH)₄ (Baker) solutions, adding the polymer to form 1% wt/vol solutions, and adjusting to the appropriate pH (NaOH or HNO₃, Fisher). Solutions were mixed for about an hour and ultrafiltered through a 10K MWCO membrane (Centracon 10 units, Amicon) using centrifugal force. The concentration of SiO₂ in permeate was determined using ICP-AES in comparison with Spex Standards. Deionized water used for dilutions was determined to contain nonmeasurable amounts of SiO₂ (detection limit ca. 1 ppm). The results are shown in Table 5 and plotted in FIG. 5 for three different polymers, PEIM, PEI-Diol, and PEI-Tartrate. There was only a very small amount of PEI-Tartrate available so it was tested at the maximum retention for the other polymers. It can be seen that there is a definite pH dependency for silica removal with the maximum for PEI-Diol and PEIM being at pH 8.8. No removal is observed at pH values below 3 for any of the polymers. Almost 100% removal is observed for PEIM at its maximum. The low removal at low pH values indicates that the polymers could be regenerated in the low pH range. The fall off of binding at very high pH also indicates that stripping with base could be an option for polymer regeneration.

TABLE 5
pH dependency study for the binding of 100 ppm Si(OH)₄ with
1% wt/v solutions of water-soluble metal-binding polymers.

| | | | % Si removal with |
|---|---|---|---|
| | % Si removal with | % Si removal with | PEI-Tartrate |
| pH | PEIM Polymer | PEI-Diol Polymer | Polymer |
| 1 | 14 | 0 | |
| 2 | 15 | 0 | |
| 3 | 16 | 0 | |
| 4 | 35 | 0 | |
| 5 | 43 | 0 | |
| 6 | 58 | 0 | |
| 7 | 73 | 2 | |
| 8 | 84 | 37 | |
| 9 | 100 | 64 | 78 |
| 10 | 100 | 50 | |
| 11 | 87 | 35 | |
| 12 | | 21 | |

### Example 11

### Binding of Arsenic and Arsenous Acid as a Function of pH with PEI-SH Polymer

All solutions were diluted to a final volume in volumetric flasks. For all tests PEI-thiol solutions were prepared fresh the day of testing by ultrasonic-assisted dissolution in water, and pH adjusted with NaOH/HCl. PEI solutions were prepared with a 12.86% by weight 30,000 MWCO aqueous PEI stock solution adjusted to the desired pH, and diluted to the correct volume. For all tests As(III) solutions were prepared fresh the day of testing by diluting a 3964 ppm arsenous acid stock solution, adjusting the pH, and diluting to the correct volume. As(V) solutions were prepared as needed by dissolving Na₂HAsO₄ in water, adjusting pH, and diluting.

In all tests, stock solutions of polymer and arsenic were prepared such that 18 mL of polymer solution and 2 mL of arsenic solution could be combined without further dilution or pH adjustment. Tests indicated that pH did not change before or after the reaction, negating the need for a buffering solution. Reactions were stirred in round bottom flasks with stir bars for one hour at room temperature unless otherwise indicated; transferring the reaction solution to a 10,000 MWCO Centriprep-10 unit and centrifuging to separate the unreacted arsenic from the polymer-arsenic complex quenched reactions. The arsenic concentration in the filtrate was quantified by ICP-AES, which was blanked with water, calibrated using three standard concentrations of arsenic and fit to a linear regression with a correlation coefficient of 0.999 or better. Filtrate concentrations always fell within the range of calibration standards. Tests were performed to determine the optimum conditions for As(III) and As(V) removal as a function of pH. Unless otherwise indicated, all tests were run at approximately 10 ppm arsenic and 3000 ppm polymer. As-binding studies were performed as a function of pH (As(III) and As(V) removal) with both PEI and PEI-ET at pH values of 2, 4, 6, 8, and 11 and As(III) removal as a function of sulfate concentration.

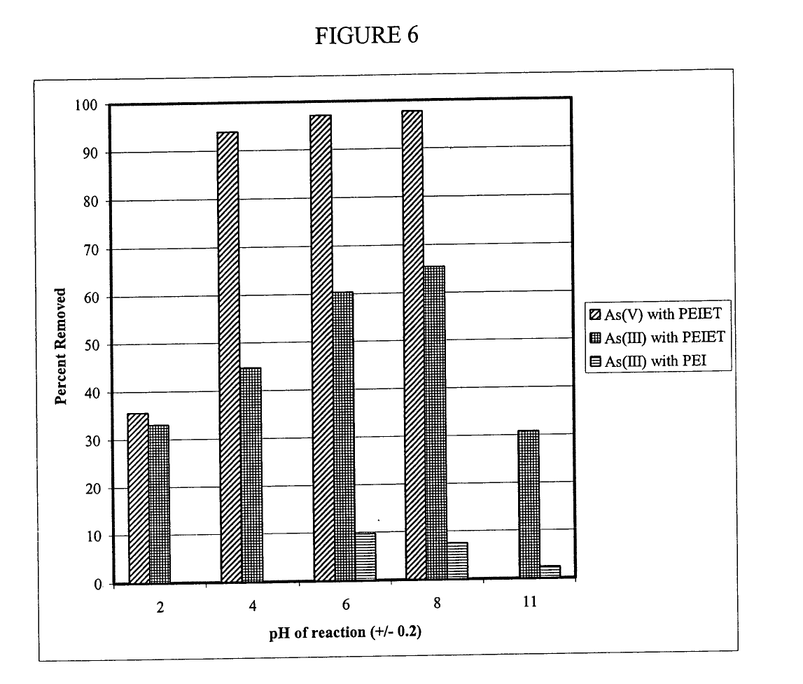

pH Dependency Studies: Arsenic removal by PEI and PEI-ET are both dependent on the pH of the aqueous solution. FIG. 6 shows the percent removal at five different pH values for As(III) with PEI and PEI-ET and As(V) with PEI-ET. It is known that the PEI polymer is a weak base anion exchanger and performs optimally in acidic solutions to bind anions. In order to bind with PEI or the PEI backbone of PEI-ET, arsenic must be an anion. The first pKa for As(III) is 9.2, thus we expect As(III) to have ionic interactions with PEI above a pH of approximately 8.5. The improvement of binding of As(III) when PEI was replaced with PEI-ET, at every pH, is attributed to the introduction of the covalently bonding sulfur groups. PEI-ET was able to remove most As(V) at neutral pH values (97%), however, this interaction is most likely an ion-pairing interaction. The pKa values of As(V) are 2.2, 6.8, and 11.6, thus at neutral pH As(V) is a mixture of mono- and dianions. Under acidic conditions (pH 2) and basic (pH 11) conditions we observed that PEI-Thiol removed less As(V) because either the As(V) was uncharged (pH 2) or the polymeric backbone was uncharged (pH 11) forbidding the formation of an ion pair. Generally, for drinking water applications we would be interested in the natural pH range of drinking water, which is between pH 6 to 8 and in that region the maximum amount of both As(III) and As(V) removal was observed.

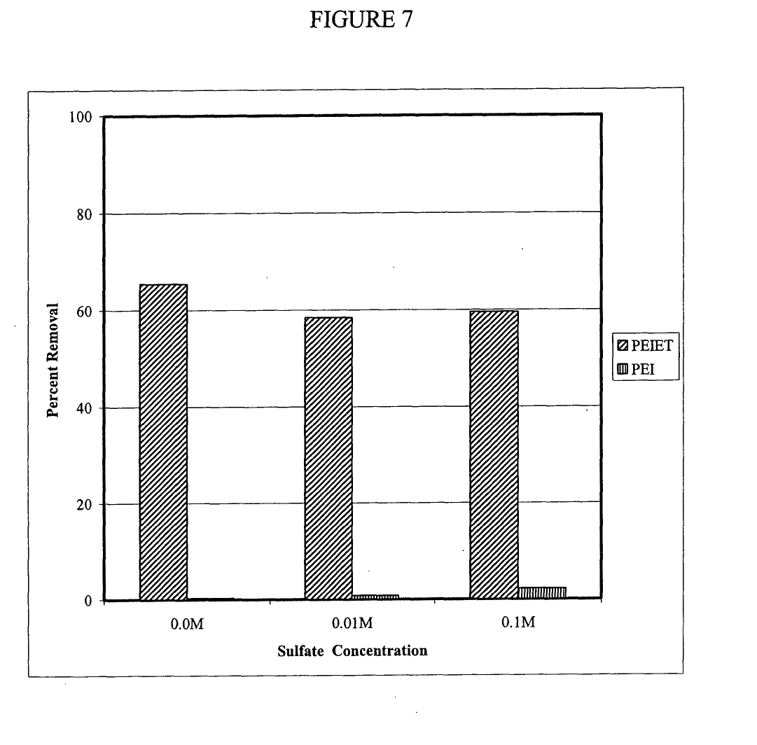

PEI-ET removal efficiencies of As(III) at high sulfate concentrations were tested and the results indicated that sulfate was not an aggressive competitor to As(III) for PEI-ET as shown in FIG. 7. There was a small change in As(III) removal at 0.01 M sulfate and 0.1 M sulfate. In the pH study discussed earlier, it was hypothesized that As(III) interaction with PEI-ET was most likely a covalent bond interaction, these sulfate studies add support to that hypothesis.

### Example 12

### Polymer Stripping by Temperature Change

We prepared a 2% wt/vol polymer PEI-diol solutions and a 3000 ppm stock solution of boric acid in DI water. Equal volumes of the polymer solution and boric acid were added (5 mL each) to prepare 3 solutions. The solutions were shaken and put into a 4° C. bath, a room temperature bath and a 40° C. bath and reacted about 1.5 hrs. Duplicate aliquots (2 mL) of each sample were placed in the Centricon-10 tubes and placed in the temperature-controlled centrifuge and centrifuged until about half of the solution permeated the membrane (3 hrs). Permeate was collected and analyzed for boron content. Table 6 gives the retention as a function of temperature. It can be seen that more polymer is bound at low temperature and less at higher temperature allowing for higher-temperature stripping of boric acid.

TABLE 6
Temperature Effect of PEI-Diol binding of boric acid.
Initial B concentration 262 ppm.

| Temperature (C.) | Permeate Concentration (ppm) | % Retained |
|---|---|---|
| 40 | 64.3 | 75.5 |
| 40 | 69.7 | 73.4 |
| 20 | 53.4 | 79.6 |
| 20 | 56.3 | 78.5 |
| 4 | 35.3 | 86.5 |
| 4 | 35.5 | 86.5 |

### Example 13

### Electrochemical Polymer Stripping

The mode of small molecule recovery from soluble polymer-guest concentrates has typically been a diafiltration process where the metal is released from the polymer by pH adjustment followed by flushing of the polymer with a dilute acid solution. Some soluble polymers are incompatible with the oxidizing power of chromic acid, and thus, the direct recovery of chromic acid for reuse has been unattainable by a diafiltration approach. A potential solution to this problem is to use electrolydialysis to remove/recover chromic acid by passing Cr(VI) through an anionic permselective membrane and collecting these ions in the anolyte chamber where protons are produced, thus giving a chromic acid concentrate that can be recycled and recovering the soluble polymer for reuse.

All electrodialysis experiments were carried out in a three-chambered Micro cell (ElectroCell, Sweden). It was of the flat plate design, which had an effective membrane/electrode surface area of approximately 10 cm². Feed, anolyte, and catholyte solutions of 500 mL total volume were held in 1 L Nalgene polyethylene bottles and were pumped through the cell using Masterflex L/S peristaltic easy load pumps. The anolyte and catholyte utilized the same pump and the feed had a separate pump, and they were calibrated so that the flow rate was the same through all compartments, approximately 55 mL per minute.

The electrochemical cell consisted of three chambers, separated from each other by an anion selective membrane—Raipore reinforced RF 4030, 5.5 mil. thick. They were previously soaked in their respective anolyte or catholyte solutions. At the cathode side, the chamber had 0.01 M NaOH flowing through it. The anode side had 0.01 M H₂SO₄ flowing through it. The center feed chamber had 0.1% polyelectrolyte with 200 ppm Mo (0.5 g polyelectrolyte and 0.2522 g MoO₄) or 200 ppm Cr (0.5 g polyelecrolyte and 0.2865 g Cr₂O₇═) at pH 12 passing through it. The power was supplied by a Sorensen DCS 60-50 power supply at a constant current of 0.1 amps and the experiment was allowed to run for six hours or more. Nitrogen gas bubbled throughout all three chambers at 10 psi.

PEI-M was found to bind chromic acid to very high levels (<99%) such that very little chromic acid permeated an ultrafiltration membrane. Such a concentrate when treated with electodialysis could recover substantial amounts of chromic acid without having to acidify the solution. During the electrodialysis runs, samples were removed periodically and collected in vials for subsequent analysis. The concentration of chromic acid and sulfur in the feed and anolyte was determined with Inductively Coupled Plasma (ICP).

The first experiment was to see how much chromium would cross through the membrane without any polymer present at room temperature (about 20° C.). The feed decreased from 170 ppm Cr to 32, which is an 81% removal. Chromate (157 ppm) was recovered in the H₂SO₄, which is a good mass balance. The next experiment was with PEIM present at room temperature. The feed decreased from 216 ppm to 117 ppm, which is a 46% removal. The H₂SO₄ recovered 94 ppm. Next, the same experiment was performed, except at an elevated temperature (50° C.). There was almost no advantage to the higher temperature. The feed decreased from 187 ppm to 94 ppm, which is a 50% removal. The H₂SO₄ recovered 89 ppm. Finally, a continuous spiking experiment was run. The membranes from the previous experiment were reused, to see if they were affected by extended use. They were not. Every hour, 50 ppm of chromic acid added to the feed chamber. The Cr appears to cross through the membrane at a constant rate.

### SUMMARY

In summary, a method of selective separation of small molecules from aqueous solutions is present. The method can be used to remove contaminants such as boric acid and silicic acid and the like from water as well as other inorganic and organic small molecules such as neutrals, acids, bases, polypeptides, amino acids, drugs, and the like. The method employs a water-soluble polymer which can form a guest-host complex with the desired small molecule. The complex can be removed from a solution by ultrafiltration and concentrated. The small molecule can then be released from the polymer for recovery and the polymer recycled for other removal/recovery operations.

1. A method of selectively separating a target small molecule from an aqueous solution comprising:
contacting the aqueous solution with a water-soluble polymer that is capable of forming a water-soluble polymer/small-molecule complex with the target small molecule for a time sufficient to allow the target small molecule to form the complex with the water-soluble polymer; and
treating the aqueous solution by ultrafiltration with an ultrafiltration membrane, the ultrafiltration membrane being selected to separate the target small molecule from the solution by having the water and the other dissolved chemicals pass through the membrane while the water-soluble polymer/molecule complex and water-soluble polymer is retained and concentrated into an aqueous solution containing water-soluble polymer/molecule complex and water-soluble polymer.

2. The method of claim 1, wherein the water-soluble polymer is initially dissolved in a reaction solution, the contacting comprising mixing the aqueous solution with the reaction solution.

3. The method of claim 1, further comprising releasing the target small molecule from the aqueous solution containing water-soluble polymer/molecule complex.

4. The method of claim 3, wherein the target small molecule is selected from the group consisting of sulfuric acid, phosphoric acid, boric acid, arsenic acid, perchloric acid, arsenous acid, silicic acid, selenic acid, selenious acid, antimonous acid, iodine, ammonia, organic acids including acrylic acid, N-methyliminodiacetic acid, DTPA, nitrilotriacetic acid, inimododiacetic acid, and ethylenediaminetetraacetic acid, organic amine bases including methylamine and dimethylamine in general, and aromatic amines and polyamines, organic neutral molecules including alcohols, aldehydes, nitrites, amides, maleimide, maleonitrile, fumaronitrile, and acrylamide, food additives, drugs, pesticides, polypeptides, antibodies, pharmaceutical compounds, antibiotics, coenzymes, and nucleic acids.

5. The method of claim 3 wherein the target small molecule is released by adding a stripping solution to the aqueous solution containing water-soluble polymer/molecule complex.

6. The method of claim 5 wherein the stripping solution comprises one or more of the following: deionized water, basic solution, acidic solution, organic solvents, hot water, cold water, and competing ligands.

7. The method of claim 3 wherein the target small molecule is released by electrodialysis.

8. The method of claim 1, wherein the target small molecule is selected from the group consisting of sulfuric acid, phosphoric acid, boric acid, arsenic acid, perchloric acid, arsenous acid, silicic acid, selenic acid, selenious acid, antimonous acid, iodine, ammonia. organic acids including acrylic acid, N-methyliminodiacetic acid, DTPA, nitrilotriacetic acid, inimododiacetic acid, and ehylenediaminetetraacetic acid, organic amine bases including methylamine dimethylamine, alkylamines in general, and aromatic amines and polyamines, organic neutral molecules including alcohols, aldehydes, nitriles, amides, maleimide, maleonitrile, fumaronitrile, and acrylamide, food additives, drugs, herbicides pesticides, polypeptides, antibodies, pharmaceutical compounds, antibiotics, coenzymes, and nucleic acids.

9. The method of claim 1, wherein the water-soluble polymer contains one or more binding groups selected to bind the target small molecule.

10. The method of claim 9, wherein the one or more binding groups are selected from the group consisting of diol derivatives, triol derivatives, tetraol derivatives, glucuron derivatives, thiol derivatives, dithiol derivatives, amide derivatives, polyphosphonic acid derivatives, guanidinum derivatives, carboxylate derviatives, permethylate derivatives, cavity-containing host groups, molecules containing a boron atom capable of functioning as a Lewis acid center, and affinity groups.

11. The method of claim 10, wherein the water-soluble polymer has a formula selected from the group consisting of 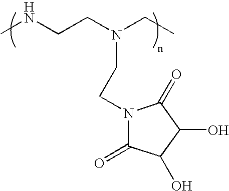
wherein n is an integer between about 12 and about 12,000; 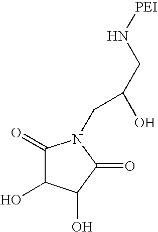
wherein PEI represents polyethylenimine having a molecular weight in the range from about 5,000 to about 100,000; 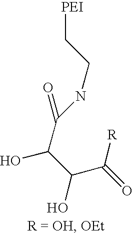
wherein PEI represents polyethylenimine having a molecular weight in the range from about 5,000 to about 100,000; 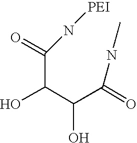
wherein PEI represents polyethylenimine having a molecular weight in the range from about 5,000 to about 100,000; and 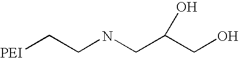
wherein PEI represents polyethylenimine having a molecular weight in the range from about 5,000 to about 100,000; 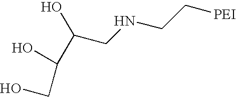
wherein PEI represents polyethylenimine having a molecular weight in the range from about 5,000 to about 100,000; 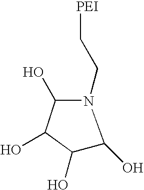
wherein PEI represents polyethylenimine having a molecular weight in the range from about 5,000 to about 100,000; 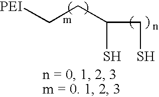
wherein PEI represents polyethylenimine having a molecular weight in the range from about 5,000 to about 100,000;

12. The method of claim 1, wherein the water-soluble polymer comprises a water-soluble backbone polymer with attached small molecule binding groups.

13. The method of claim 12, wherein the backbone polymer is selected from the group consisting of polyvinylamine, polyallylamine, polyacrylamide, polyethylenimine, polyacrylic acid, polymethacrylic acid, polyvinylalcohol, polyvinylacetate, polypyrrol, and hyperbranched polymers.

14. The method of claim 12, wherein the binding groups are selected from the group consisting of a tartrate deriviative, a diol, a triol, a tetraol, a thiol, a dithiol, a cavity-containing host groups, cage-shaped host, a calixarene-containing polymer, a cyclodetran containing polymer, molecules containing a boron atom capable of functioning as a Lewis acid center, an antibody, a Fab fragment of an antibody, a F(ab)₂ of an antibody an antigen, and a polypeptide.

15. The method of claim 14, wherein the backbone polymer is polyethylenimine.

16. The method of claim 1, wherein the water-soluble polymer is selected from the group consisting of polyethylenimine, permethylated polyethylenimine, guanidinium polyethylenimine, carboxylated polyethylenimine, phosphoralated polyethylenimine, poly(ethylenimine ethyenesulfide), glycidol polyethylenimine, tartrated polyethylenimine, diphosphoralated polyethylenimine, polyvinylamine, polyacrylic acid, polyvinylalcohol, polyvinylacetate, polypyrrol, polymethacrylic acid, and hyperbranched polymers.

17. The method of claim 16, wherein the water-soluble polymer has a molecular weight in the range from about 5,000 to about 100,000.

18. The method of claim 17, further comprising releasing the target small molecule from the aqueous solution containing water-soluble polymer/molecule complex.

19. The method of claim 17, further comprising releasing the target small molecule from the aqueous solution containing water-soluble polymer/molecule complex.

20. A method of selectively separating a target small molecule from an aqueous solution comprising:
contacting the aqueous solution with a water-soluble polymer that is capable of forming a water-soluble polymer/molecule complex with the target small molecule for a time sufficient to allow the target small molecule to form the complex with the water-soluble polymer, the water-soluble polymer having been pre-purified so as to have polymer molecule sizes capable of being retained by an ultrafiltration membrane with a molecular weight cutoff value of a first pre-selected level and essentially free of polymer molecule sizes capable of passing through a membrane with a molecular weight cutoff value of a second pre-selected level, the first pre-selected level being larger than the second pre-selected level; and
treating the aqueous solution by ultrafiltration with an ultrafiltration membrane, the ultrafiltration membrane being selected to separate the target small molecule from the solution by having the water and the other dissolved chemicals pass through the membrane while the water-soluble polymer/molecule complex is retained and concentrated into an aqueous solution containing water-soluble polymer/molecule complex.

21. The method of claim 20, wherein the water-soluble polymer is initially dissolved in a reaction solution, the contacting comprising mixing the aqueous solution with the reaction solution.

22. The method of claim 20, further comprising releasing the target small molecule from the aqueous solution containing water-soluble polymer/molecule complex.

23. The method of claim 22, wherein the target small molecule is selected from the group consisting of sulfuric acid, phosphoric acid, boric acid, arsenic acid, perchloric acid, arsenous acid, silicic acid, selenic acid, selenious acid, antimonous acid, iodine, ammonia, organic acids including acrylic acid, N-methyliminodiacetic acid, DTPA, nitrilotriacetic acid, inimododiacetic acid, and ethylenediaminetetraacetic acid, organic amine bases including methylamine and dimethylamine, organic neutral molecules including alcohols, aldehydes, nitrites, amides, maleimide, maleonitrile, fumaronitrile, and acrylamide, food additives, drugs, pesticides, polypeptides, antibodies, pharmaceutical compounds, antibiotics, coenzymes, and nucleic acids.

24. The method of claim 22 wherein the target small molecule is released by adding a stripping solution to the aqueous solution containing water-soluble polymer/molecule complex.

25. The method of claim 24 wherein the stripping solution comprises one or more of the following: deionized water, basic solution, acidic solution, organic solvents, hot water, cold water, and competing ligands.

26. The method of claim 22 wherein the target small molecule is released by electrodialysis.

27. The method of claim 20, wherein the target small molecule is selected from the group consisting of sulfuric acid, phosphoric acid, boric acid, arsenic acid, perchloric acid, arsenous acid, silicic acid, selenic acid, selenious acid, antimonous acid, iodine, ammonia organic acids including acrylic acid, N-methyliminodiacetic acid, DTPA, nitrilotriacetic acid, inimododiacetic acid, and ethylenediaminetetraacetic acid, organic amine bases including methylamine dimethylamine, alkylamines in general, and aromatic amines and polyamines, organic neutral molecules including alcohols, aldehydes, nitriles, amides, maleimide, maleonitrile, fumaronitrile, and acrylamide, food additives, drugs, herbicides pesticides, polypeptides, antibodies, pharmaceutical compounds, antibiotics, coenzymes, and nucleic acids.

28. The method of claim 20, wherein the water-soluble polymer contains one or more binding groups selected to bind the target small molecule.

29. The method of claim 28, wherein the one or more binding groups are selected from the group consisting of diol derivatives, triol derivatives, tetraol derivatives, thiol derivatives, dithiol derivatives, amide derivatives, polyphosphonic acid derivatives, guanidinum derivatives, carboxylate derviatives, permethylate amine derivatives, cavity-containing host groups, a cage-shaped host, a calixarene-containing polymer, a cyclodetran-containing polymer, molecules containing a boron atom capable of functioning as a Lewis acid center, and affinity groups.

30. The method of claim 29, wherein the water-soluble polymer has a formula selected from the group consisting of 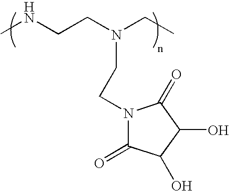
wherein n is an integer between about 12 and about 12,000; 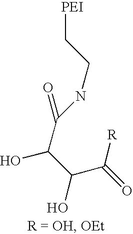
wherein PEI represents polyethylenimine having a molecular weight in the range from about 5,000 to about 100,000; 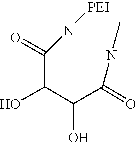
wherein PEI represents polyethylenimine having a molecular weight in the range from about 5,000 to about 100,000; 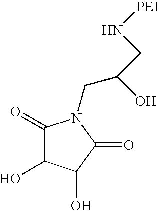
wherein PEI represents polyethylenimine having a molecular weight in the range from about 5,000 to about 100,000; and 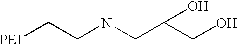
wherein PEI represents polyethylenimine having a molecular weight in the range from about 5,000 to about 100,000 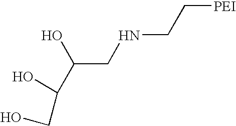
wherein PEI represents polyethylenimine having a molecular weight in the range from about 5,000 to about 100,000; 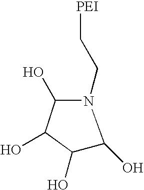
wherein PEI represents polyethylenimine having a molecular weight in the range from about 5,000 to about 100,000; 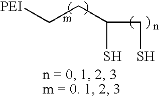
wherein PEI represents polyethylenimine having a molecular weight in the range from about 5,000 to about 100,000;

31. The method of claim 20, wherein the water-soluble polymer comprises a water-soluble backbone polymer with attached small molecule binding groups.

32. The method of claim 31, wherein the backbone polymer is selected from the group consisting of polyvinylamine, polyallylamine, polyacrylamide, polyethylenimine, polyacrylic acid, polymethacrylic acid, polyvinylalcohol, polyvinylacetate, polypyrrol, and hyperbranched polymers.

33. The method of claim 31, wherein the binding groups are selected from the group consisting of a tartrate deriviative, a diol, a triol, a tetraol, a thiol, a dithiol, a cage-shaped host, cavity-containing host groups, a calixarene-containing polymer, a cyclodextran-containing polymer, an antibody, a Fab fragment of an antibody, a F(ab)₂ of an antibody an antigen, molecules containing a boron atom capable of functioning as a Lewis acid center, and a polypeptide.

34. The method of claim 33, wherein the backbone polymer is polyethylenimine.

35. The method of claim 20, wherein the water-soluble polymer is selected from the group consisting of polyethylenimine, permethylated polyethylenimine, guanidinium polyethylenimine, carboxylated polyethyleneimine, phosphoralated polyethylenimine, poly(ethylenimine ethyenesulfide), glycidol polyethylenimine, tartrated polyethylenimine, diphosphoralated polyethylenimine, polyvinylamine, polyacrylic acid, polyvinylalcohol, polyvinylacetate, polypyrrol polymethylacrylic acid, and hyperbranched polymers.

36. The method of claim 35, wherein the water-soluble polymer has a molecular weight in the range from about 5,000 to about 100,000.

37. The method of claim 36, further comprising releasing the target small molecule from the aqueous solution containing water-soluble polymer/molecule complex.

38. A method of selectively separating a target small molecule from an aqueous solution comprising:
contacting the aqueous solution with a water-soluble polymer that is capable of forming a water-soluble polymer/molecule complex with the target small molecule for a time sufficient to allow the target small molecule to form the complex with the water-soluble polymer, the target small molecule being selected from the group consisting of boric acid, arsenic acid, arsenous acid, selenous acid, selenic acid, antimonous acid, the water-soluble polymer having been pre-purified so as to have polymer molecule sizes capable of being retained by an ultrafiltration membrane with a molecular weight cutoff value of a first pre-selected level and essentially free of polymer molecule sizes capable of passing through a membrane with a molecular weight cutoff value of a second pre-selected level, the first pre-selected level being larger than the second pre-selected level; and
treating the aqueous solution by ultrafiltration with an ultrafiltration membrane, the ultrafiltration membrane being selected to separate the target small molecule from the solution by having the water and the other dissolved chemicals pass through the membrane while the water-soluble polymer/molecule complex is retained and concentrated into an aqueous solution containing water-soluble polymer/molecule complex.

39. The method of claim 38, wherein the water-soluble polymer is initially dissolved in a reaction solution, the contacting comprising mixing the aqueous solution with the reaction solution.

40. The method of claim 38, further comprising releasing the target small molecule from the aqueous solution containing water-soluble polymer/molecule complex.

41. The method of claim 40 wherein the target small molecule is released by adding a stripping solution to the aqueous solution containing water-soluble polymer/molecule complex.

42. The method of claim 41 wherein the stripping solution comprises one or more of the following: deionized water, basic solution, acidic solution, organic solvents, hot water, cold water, and competing ligands.

43. The method of claim 40 wherein the target small molecule is released by electrodialysis.

44. The method of claim 38, wherein the water-soluble polymer contains one or more binding groups selected to bind the target small molecule, the binding groups being selected from the group consisting of a tartrate derivative and a diol derivative.

45. The method of claim 38, wherein the water-soluble polymer has a formula selected from the group consisting of 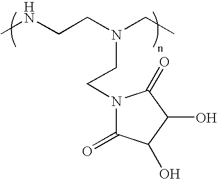
wherein n is an integer between about 12 and about 12,000; 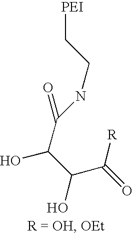
wherein PEI represents polyethylenimine having a molecular weight in the range from about 5,000 to about 100,000; 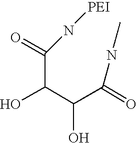
wherein PEI represents polyethylenimine having a molecular weight in the range from about 5,000 to about 100,000; 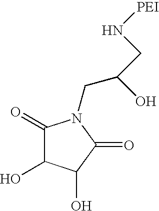
wherein PEI represents polyethylenimine have a molecular weight in the range from about 5,000 to about 100,000; and 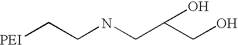
wherein PEI represents polyethylenimine with a molecular weight in the range from about 5,000 to about 100,000 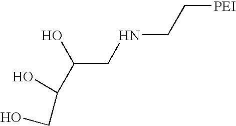
wherein PEI represents polyethylenimine having a molecular weight in the range from about 5,000 to about 100,000; 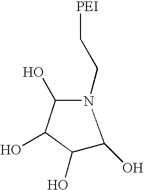
wherein PEI represents polyethylenimine having a molecular weight in the range from about 5,000 to about 100,000; 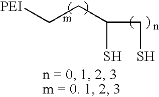
wherein PEI represents polyethylenimine having a molecular weight in the range from about 5,000 to about 100,000;

46. The method of claim 45, wherein the water-soluble polymer has a molecular weight in the range from about 5,000 to about 100,000.

47. The method of claim 38, wherein the water-soluble polymer is polyethylenimine, permethylated polyethylenimine, guanidinium polyethylenime, phosphoralated polyethyleneimine, poly(ethylenimine ethyenesulfide), glycidol polyethylenimine, tartrated polyethylenime, diphosphoralated polyethylenime, polyvinylamine, or polyallylamine.

48. A method of selectively separating chromic acid and perchloric acid from an aqueous solution comprising:
contacting the aqueous solution with a water-soluble polymer that is capable of forming a water-soluble polymer/molecule complex with the chromic acid for a time sufficient to allow the target small molecule to form the complex with the water-soluble polymer; and
treating the aqueous solution by ultrafiltration with an ultrafiltration membrane, the ultrafiltration membrane being selected to separate the chromic acid from the solution by having the water and the other dissolved chemicals pass through the membrane while the water-soluble polymer/molecule complex is retained and concentrated into an aqueous solution containing water-soluble polymer/molecule complex.

49. The method of claim 48, wherein the water-soluble polymer is initially dissolved in a reaction solution, the contacting comprising mixing the aqueous solution with the reaction solution.

50. The method of claim 48, further comprising releasing the chromic acid or perchloric acid from the aqueous solution containing water-soluble polymer/molecule complex via eletrolydialysis.

51. The method of claim 48, wherein the water-soluble polymer comprises permethylated polyethylenimine.
